(19) United States
(12) Patent Application Publication
(10) Pub. No.: US 2023/0010595 A1
(43) Pub. Date: Jan. 12, 2023

(54) WET SAW HEATER

(71) Applicant: Sauder Tile, LLC, Mercersburg, PA (US)

(72) Inventor: Steven Allan Sauder, Mercersburg, PA (US)

(21) Appl. No.: 17/834,519

(22) Filed: Jun. 7, 2022

Related U.S. Application Data
(60) Provisional application No. 63/218,578, filed on Jul. 6, 2021.

(51) Int. Cl. B23Q 11/10; B28D 7/02

(52) U.S. Cl. CPC B23Q 11/1038; B28D 7/02

(57) ABSTRACT

The present teachings include techniques for regulating the temperature of coolant used for a wet saw and the like. That is, a wet saw usually accommodates a coolant tank and/or tray, where coolant is pumped therefrom to the saw blade and/or an interface between the saw blade and a material to be cut (e.g., tile), e.g., to lubricate and cool the saw blade. However, when using a wet saw in colder environments, freezing can be a problem. While submersible “bucket heaters” and the like may be used, these heaters can be cumbersome, faulty, and dangerous. Therefore, the present teachings may include a reservoir with an integrated heating element that is built into the tank/tray itself (e.g., within its base), such that the heating element is physically isolated from the coolant contained therein. Such a heated reservoir may be retrofitted onto an existing saw and/or fabricated with the saw itself.

### CROSS-REFERENCE TO RELATED APPLICATIONS

This application claims priority to U.S. Provisional Pat. App. No. 63/218,578 filed on Jul. 6, 2021, the entire content of which is hereby incorporated by reference.

### FIELD

The present disclosure generally relates to devices, systems, kits, and methods for a saw heater—e.g., devices, systems, kits, and methods related to heating a coolant used for a saw blade interface in a wet saw to prevent freezing of the coolant during use of the wet saw in cold environments.

### BACKGROUND

Some saws benefit from the use of a coolant applied at an interface between a saw blade and a material being cut by the blade, where such a coolant may include water or the like. Saws of this kind are generally referred to as “wet saws,” and a popular type of wet saw includes one used for cutting ceramic tile and the like. In general, a wet saw may utilize a powered, spinning, diamond-embedded blade to cut tile (and the like) accurately, safely, and quickly. Wet saws may be similar to table saws, but typically further include a reservoir for housing a coolant, which as stated above may include water or the like. The coolant may lubricate and cool the saw blade, while also mitigating against airborne dust. When used in colder environments, such as those with a temperature at or below the freezing temperature of water (or other coolant used), the coolant (e.g., water) used for a wet saw may be susceptible to freezing. There remains a need for improved wet saw heaters and components related thereto.

### SUMMARY

The present teachings include techniques for regulating the temperature of coolant used for a wet saw and the like. That is, a wet saw usually accommodates a coolant tank and/or tray, where coolant is pumped therefrom to the saw blade and/or an interface between the saw blade and a material to be cut (e.g., tile), e.g., to lubricate and cool the saw blade. However, when using a wet saw in colder environments, freezing can be a problem. While submersible “bucket heaters” and the like may be used, these heaters can be cumbersome, faulty, and dangerous. Therefore, the present teachings may include a reservoir with an integrated heating element that is built into the tank/tray itself (e.g., within its base), such that the heating element is physically isolated from the coolant contained therein. Such a heated reservoir may be retrofitted onto an existing saw and/or fabricated with the saw itself.

In one aspect, a system for cutting tile and similar disclosed herein may include: a cutting surface; a blade having an edge at least partially exposed along the cutting surface and aligned along a cutting path such that an item placed on the cutting surface and moved along the cutting path toward the blade will contact the edge of the blade; a motor engaged with the blade to move the blade relative to the cutting surface to facilitate cutting the item when contacting the blade with a predetermined force; a reservoir including a bottom surface and one or more sidewalls extending upward from the bottom surface, the reservoir defining a coolant volume configured to contain a coolant therein; a pump in fluid communication with the coolant volume; and a fluid line structurally configured to deliver coolant moved via the pump from the coolant volume to the blade when the pump is actuated. The system may also include a heating element disposed within one or more of the bottom surface and the one or more sidewalls of the reservoir, the heating element selectively activatable to heat coolant contained within the coolant volume to maintain a minimum predetermined temperature thereof.

Implementations may include one or more of the following features. The heating element may be physically isolated from coolant contained within the coolant volume. The reservoir may be removable and replaceable within the system. At least one of the bottom surface and one or more of the sidewalls may be made from a thermally conductive resin. The system may further include a controller configured to control operation of the heating element. The system may further include a thermostat in thermal communication with the coolant volume and configured to sense a temperature of coolant contained therein, the thermostat in communication with the controller to relay the temperature to the controller for activating the heating element when the sensed temperature is a predetermined value. The predetermined value of the sensed temperature may be the minimum predetermined temperature. The predetermined value of the sensed temperature may be adjustable by a user of the system. The thermostat may be engaged with one or more of the bottom surface and one or more of the sidewalls of the reservoir. The thermostat may be disposed within one or more of the bottom surface and one or more of the sidewalls of the reservoir. The system may further include a first power line configured to provide electricity from a first power source to one or more of the motor, the pump, and the heating element. The first power source may be in communication with each of the motor, the pump, and the heating element for providing power thereto for operation thereof. The system may further include a second power line independent from the first power line and configured to provide electricity to the heating element, where the heating element is electrically independent from the first power line. The system may further include a second power source configured to provide electricity through the second power line to the heating element for operation thereof. The first power source and the second power source may be different. Electricity transmitted through the second power line may be 50 volts or less. The system may further include an electrical connector disposed at a first end of the second power line, where the heating element is disposed at a second end of the second power line. The electrical connector may be disposed on or adjacent to the reservoir.

In one aspect, a device structurally configured for use with a wet saw disclosed herein may include: a reservoir including a bottom surface and one or more sidewalls extending upward from the bottom surface, the reservoir defining a coolant volume configured to contain a coolant therein; a heating element disposed within one or more of the bottom surface and one or more sidewalls of the reservoir, the heating element selectively activatable to heat coolant contained within the coolant volume to maintain a minimum predetermined temperature thereof; a controller configured to control operation of the heating element; and a thermostat in thermal communication with the coolant volume and configured to sense a temperature of coolant contained therein, the thermostat in communication with the controller to relay the temperature to the controller for activating the heating element when the sensed temperature is a predetermined value.

Implementations may include one or more of the following features. The reservoir may be sized and shaped for inserting within a housing of a wet saw. The reservoir may include one or more connectors for engagement to at least a portion of a wet saw. At least one of the bottom surface and one or more sidewalls may be made from a thermally conductive resin. The device may further include a power line configured to provide electricity from a power source to one or more components of the device. The predetermined value may be above a freezing point of coolant contained within the coolant volume. The predetermined value may be adjustable by a user of the device. The thermostat may be engaged with one or more of the bottom surface and one or more sidewalls of the reservoir. The thermostat may be disposed within one or more of the bottom surface and the one or more sidewalls of the reservoir.

In one aspect, a method disclosed herein may include positioning a heating element within one or more of a bottom surface and a sidewall of a reservoir of a wet saw, the reservoir defining a coolant volume configured to contain a coolant therein; positioning a thermostat in thermal communication with the coolant volume; sensing, via the thermostat, a temperature of coolant contained within the coolant volume; communicating the temperature of the coolant as sensed by the thermostat to a controller; and activating, via the controller, the heating element when the temperature of the coolant is below a predetermined threshold. Positioning the heating element within the reservoir may include forming the reservoir around the heating element via a manufacturing process including one or more of injection molding, three-dimensional printing, and thermoforming.

These and other features, aspects, and advantages of the present teachings will become better understood with reference to the following description, examples, and appended claims.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1 illustrates a system for cutting tile and similar, in accordance with a representative embodiment.

FIG. 2 illustrates a device structurally configured for use with a wet saw, in accordance with a representative embodiment.

FIG. 3 illustrates a system for cutting tile and similar, in accordance with a representative embodiment.

FIG. 4 illustrates a tool system, in accordance with a representative embodiment.

FIG. 5 is a flow chart of a method for controlling temperature of coolant for a tool, in accordance with a representative embodiment.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “about,” “approximately,” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

In general, the devices, systems, kits, and methods disclosed herein generally relate to heating a component of a wet saw or the like (and/or an accessory to a wet saw or the like). More specifically, the devices, systems, kits, and methods disclosed herein may include heating a coolant used for a saw blade interface of a wet saw to prevent freezing of the coolant during use of the wet saw in relatively cold environments (e.g., environments where the temperature of the coolant is at risk of falling below a freezing point of the coolant). In this manner, the present teachings may include a device structurally configured for use with a wet saw, such as a reservoir (e.g., a tray, container, tank, trough, tub, or the like) with an integrally-built-in heating element that does not itself physically contact the coolant contained within the reservoir. By way of example, the present teachings may be configured for use with a wet saw that is structurally configured for cutting ceramic tile and the like. However, it will be understood that the present teachings may also or instead include, or otherwise be adapted for use with, other types of saws and tools that require or otherwise benefit from a coolant stored in a reservoir thereof or engaged thereto. Thus, unless explicitly stated to the contrary or otherwise clear from the context, a “wet saw” as used herein will be understood as being substitutable with one or more such tools.

The “coolant” described herein may include water. However, it will be understood that other types of coolants may also or instead be utilized in the devices, systems, kits, and methods of the present teachings.

The present teachings may thus generally include techniques for regulating the temperature of a coolant (e.g., water) used for a tool (e.g., a wet saw and the like). That is, the present teachings may include techniques for heating a coolant of a wet saw when the coolant is detected to be approaching, at, or below a threshold temperature, such as the freezing temperature for water at sea level (i.e., about 0 degrees Celsius) or otherwise the freezing temperature for the coolant. However, unlike existing submersible “bucket heaters” and the like—which can be cumbersome, faulty, and dangerous at least because of their direct contact with the coolant or the like—the present teachings may include a reservoir with an integrated heating element that is built into the housing of the reservoir itself (e.g., within its base), such that the heating element is physically isolated from the coolant contained therein. Also, and advantageously, such a heated reservoir may be retrofitted onto an existing saw and/or fabricated to be included with a new saw. Moreover, another advantage over bucket heaters and the like can include that, using the present teachings, the heating can be localized to the cutting surface as opposed to a separate bucket. By way of example, using a tray according to the present teachings, coolant left in a tray for a prolonged period of time (e.g., overnight) can be easily heated simply by turning on the heater power to the tray, whereas prior art techniques can require chipping away the ice or using very hot water to melt ice within a tray.

Further advantages of the present teaching (e.g., over existing submersible “bucket heaters” and the like) may include isolation of a heating element from contents of a reservoir, which may include the coolant and other contents. For example, sediment from material being cut or otherwise processed by the tool may be present in the reservoir—e.g., tile sediment is known to accumulate in the reservoir/tray of wet saws—and isolating a heating element from this sediment or the like may promote safety and effectiveness, as well as prolong the life of such a heating element. That is, if a heating element is integral with a tray of a wet saw such that it does not directly touch contents thereof, this can alleviate some issues associated with heaters merely being present within a volume defined by the reservoir.

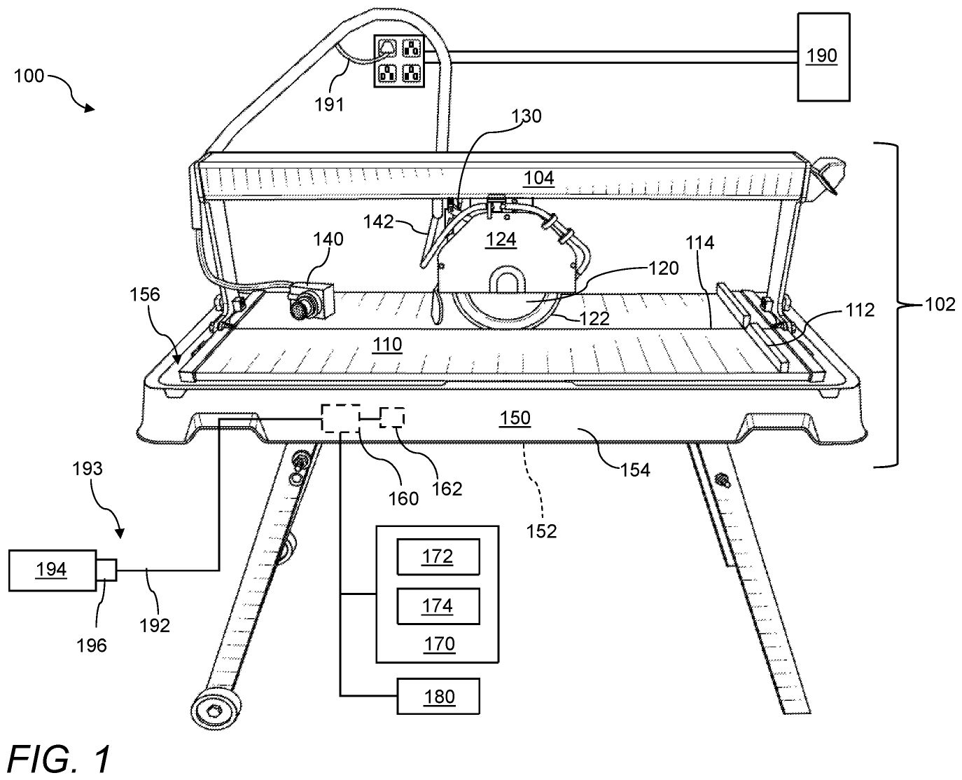

FIG. 1 illustrates a system for cutting tile and similar, in accordance with a representative embodiment. The system 100 may include a wet saw 102, which as described herein may include any saw, tool, or the like that benefits from a coolant (e.g., water or the like) and thus cooperates with a reservoir 150 structurally configured to hold the coolant therein. The system 100 may thus further include a cutting surface 110, a blade 120, a motor 130, a pump 140, the reservoir 150, and a heating element 160 (which will be understood is included in a representative form within this figure).

The cutting surface 110 may include any working surface, e.g., for which to cut material using the blade 120 of the wet saw 102. Thus, the cutting surface 110 may include any features commonly found on wet saws 102, such as a portion that is movable to change an angle of the cutting surface 110 relative to an edge 122 of the blade 120 (e.g., for cutting material at a predetermined angle). The cutting surface 110, or the wet saw 102 more generally, may also or instead include one or more stabilizers 112 (e.g., a shoe, a guide, a brace, or the like) on the cutting surface 110, where such a stabilizer 112 may be movable relative to the cutting surface 110 and the blade 120, and where a position of the stabilizer 112 may be releasably lockable relative to the cutting surface 110. The cutting surface 110 may generally define a cutting path along which the blade 120 is disposed, such that moving material along the cutting path and/or moving the blade 120 along the cutting path will cause the blade 120 to engage the material for a mechanical interaction such as cutting, grinding, carving, drilling, and the like. In certain aspects, a slot 114 is formed in the cutting surface 110 at least partially along the cutting path to accommodate at least a portion of the blade 120.

The blade 120 may include an edge 122 at least partially exposed along the cutting surface 110 and aligned along the cutting path such that an item placed on the cutting surface 110 and moved along the cutting path toward the blade 120 will contact the edge 122 of the blade 120. In certain aspects, the blade 120 includes a substantially circular (e.g., disc-shaped) blade that is rotatable via the motor 130 for cutting or performing another similar function. The blade 120 may also or instead be movable laterally along the cutting path of the cutting surface 110, e.g., via a positioning gantry 104 or the like. In lieu of, or in addition to, the blade 120, it will be understood that the system 100 may include a drill bit, a grinder, and/or other tools that can benefit from a coolant applied thereto during operation thereof. The system 100 may further include one or more safety features commonly found on tools such as a wet saw 102 such as a safety guard 124 that is movable to cover at least a portion of the blade 120.

The motor 130 may be mechanically engaged with the blade 120 to move the blade 120 (e.g., rotate the blade 120) relative to the cutting surface 110 in a manner to facilitate cutting an item (e.g., tile) when contacting the blade 120 with a predetermined force. The motor 130 may include any as known in the art. In some aspects, the motor 130 is powered separately from other components of the system 100 such as the pump 140 and the heating element 160.

The pump 140 may be structurally configured to move the coolant (e.g., a liquid coolant such as water or the like) from the reservoir 150 to another location such as an interface between the blade 120 and an item to be cut such as tile. Thus, although shown on the cutting surface 110 in the figure for convenience and understanding, the pump 140 may be in fluid communication with the contents of the reservoir 150 (e.g., the pump 140 may be located within, or otherwise in fluid communication with, a coolant volume 156 defined by the reservoir 150). Stated otherwise, the pump 140 may be in fluid communication with the coolant volume 156. The pump 140 may further be in fluid communication with the location upon which the pump 140 is configured to move the coolant to, such as the interface between the blade 120 and an item to be cut. To this end, the system 100 may include one or more corresponding fluid lines 142 or the like to facilitate such transport of the coolant from a first location (e.g., within the reservoir 150) to a second location (e.g., a cutting interface or other mechanical interface that benefits from cooling via the coolant). That is, the system 100 may include a fluid line 142 structurally configured to deliver coolant moved via the pump 140 from the coolant volume 156 to the blade 120 when the pump 140 is actuated. The pump 140 may include any as known in the art.

As demonstrated by the description above, a wet saw 102 may include many components. To this end, it may be desirable to have any accessories or additions to such a wet saw 102 be relatively compact or simplified. That is, it may be disadvantageous to add complexity to a system 100 through the addition of a plurality of wires, cables, components, and the like.

The reservoir 150 may include a bottom surface 152 and one or more sidewalls 154 extending upward from the bottom surface 152. In this manner, the reservoir 150 may define a coolant volume 156 structurally configured to contain a coolant therein. To this end, the reservoir 150 may include a tray, a trough, a container, a tub, combinations thereof, and/or one or more other similar structures that are configured to house a liquid therein such as water and the like. The reservoir 150 may be removable and replaceable within the system 100. That is, in some aspects, the reservoir 150 may be a standalone piece of the system 100. In this manner, the reservoir 150 may be adapted to work with and/or engage with one or more wet saws 102 such as that shown in the figure or otherwise. Thus, a reservoir 150 according to the present teachings may be used to retrofit a tool of the prior art, such as a tile saw that does not otherwise include a component that can regulate temperature of a coolant, e.g., to prevent that coolant from freezing in relatively cold conditions. In other aspects, the reservoir 150 may be integral with the wet saw 102 or another similar tool—e.g., the reservoir 150 according to the present teachings may be built into a tile saw or the like during construction thereof.

As discussed herein, the reservoir 150 may include a heating element 160 that is integral with the structure of the reservoir 150 itself (e.g., a housing thereof) such that the heating element 160 is physically isolated from the coolant volume 156 (i.e., not in direct contact such that liquid therein cannot physically touch the heating element 160 during normal operation). Thus, the heating element 160 may be physically isolated from the coolant volume 156, but in thermal communication therewith, such that the heating element 160 can regulate the temperature of that volume or contents therein by transferring heat thereto. Also or instead, the reservoir 150 may include a heating element 160 that is otherwise engaged with a portion of the reservoir 150. For example, an implementation may include a heating pad (e.g., a substantially waterproof heating pad) affixed to a portion of the reservoir 150, e.g., along an interior or exterior thereof, where such a heating pad may be disposed within the coolant volume 156 of the reservoir 150 or physically isolated therefrom.

The reservoir 150 may be made from one or more of a variety of materials as will be understood by a skilled artisan. Thus, the bottom surface 152 and the sidewalls 154 may be made from one or more of a variety of materials as will be understood by a skilled artisan. For example, in an aspect, at least one of the bottom surface 152 and/or a sidewall 154 is made from a thermally conductive resin. By way of further example, the resin (or other material(s) from which the reservoir 150 or a portion thereof is constructed) may be formed around one or more components of the reservoir 150 when constructed—e.g., the resin may be formed around the heating element 160 such that the heating element 160 is disposed within a portion of the reservoir 150 such as the bottom surface 152 and/or one or more of the sidewalls 154 (e.g., the heating element 160 may be substantially sealed within a structure of the reservoir 150). In this manner, the construction process may include forming the reservoir 150 in a mold that includes a heating element 160 therein, and/or three-dimensionally printing (or otherwise additive manufacturing) material about the heating element 160. Also or instead, a portion of the reservoir 150 may be fabricated, and thus structurally configured, to receive a heating element 160 therein—e.g., a slot, pocket, void, and/or the like may be formed in the reservoir 150 for receiving the heating element 160 therein.

Thus, the reservoir 150 may be made of one or more thermally conductive materials including but not limited to a resin, plastic, metal, wood (and/or a wood composite), ceramic, and the like. And thus, the reservoir 150 may be manufactured using one or more of a variety of techniques including but not limited to injection molding, three-dimensional printing or other additive manufacturing, extrusion molding, blow molding, rotational plastic molding, thermoforming, and the like.

The heating element 160 may be disposed within one or more of the bottom surface 152 and/or one or more of the sidewalls 154 of the reservoir 150. Thus, the heating element 160 may be integrated within a structure of the reservoir 150. As such, the heating element 160 may be physically isolated from coolant contained within the coolant volume 156 of the reservoir 150. This arrangement may be particular advantageous for one or more of longevity of the heating element 160, safety, convenience, adaptability, and the like.

The heating element 160 may be selectively activatable to heat coolant contained within the coolant volume 156 to maintain a minimum predetermined temperature thereof. By way of example, the minimum predetermined temperature may be just above the freezing point of water (e.g., the minimum predetermined temperature may be about 4 degrees Celsius or greater), although other temperatures are also or instead possible.

The system 100 may further include a controller 170 configured to control operation of the heating element 160. And, the system 100 may further include a thermostat 162 in thermal communication with the coolant volume 156 and configured to sense a temperature of coolant contained therein. The thermostat 162 may be in communication with the controller 170 to relay the temperature to the controller 170 for activating the heating element 160 when the sensed temperature is a predetermined value (e.g., when the sensed temperature is equal to, or approaching, the minimum predetermined temperature or another temperature or temperature range set by a user or the like). Thus, the predetermined value of the sensed temperature may be the minimum predetermined temperature in an aspect. Also or instead, the predetermined value of the sensed temperature may be adjustable by a user of the system 100. In certain aspects, the thermostat 162 is engaged with one or more of the bottom surface 152 and/or one or more of the sidewalls 154 of the reservoir 150. For example, the thermostat 162 may be disposed within one or more of the bottom surface 152 and/or one or more of the sidewalls 154 of the reservoir 150, e.g., in the same or similar manner as the heating element 160, which may be embedded within a structure of the reservoir 150 as described herein. The thermostat 162 may be any as known in the art such as one or more of bimetal snap action, a fluid filled capillary style, and a digital style thermostat switch.

The controller 170 may include, or otherwise be in communication with, a processor 172, a memory 174, a control panel or user interface, and control wiring for controlling one or more of the components of the system 100. Thus, the controller 170 may be operable to control one or more of the components of the system 100. The controller 170 may be configured to start, stop, and adjust a component of the system 100 such as the heating element 160, the pump 140, and/or the wet saw 102. The controller 170 may also or instead be configured to lock a function of, or access to, a component of the system 100, or the system 100 generally. Such control from the controller 170 may be based on signals received from one or more sensors such as the thermostat 162, or instructions received from a user or otherwise. In general, the controller 170 may be electrically coupled in a communicating relationship, e.g., an electronic communication, with any of the components of the system 100. In general, the controller 170 may be operable to control the components of the system 100, and may include any combination of software and/or processing circuitry suitable for controlling the various components of the system 100 described herein including without limitation one or more processors 172, microprocessors, microcontrollers, application-specific integrated circuits, programmable gate arrays, and any other digital and/or analog components, as well as combinations of the foregoing, along with inputs and outputs for transceiving control signals, drive signals, power signals, sensor signals, and the like. In certain implementations, the controller 170 may include the processor 172 or other processing circuitry with sufficient computational power to provide related functions such as executing an operating system, providing a graphical user interface (e.g., to a display coupled to a control panel or another component of the system 100), set and provide rules and instructions for operation of a component of the system 100, convert sensed information into instructions, notifications, and the like, and operate a web server or otherwise host remote operators and/or activity through one or more communications interfaces. In certain implementations, the controller 170 may include a printed circuit board, an Arduino controller or similar, a Raspberry Pi controller or the like, a prototyping board, or other computer related components.

The controller 170 may be a local controller disposed on a component of the system 100 (e.g., the controller 170 may be engaged with, and/or embedded within, the reservoir 150), or a remote controller otherwise in communication with the system 100 and its components. For example, one or more of the controller 170 and a user interface in communication with the controller 170 may be disposed on an external resource 180 (e.g., a computing device) in communication with the system 100 over a data network.

The processor 172 of the controller 170 may include an onboard processor for a component of the system 100. The processor 172 may also or instead be disposed on a separate computing device or an external resource 180 that is connected to the system 100 or one or more of its components through a data network, e.g., using a communications interface, which may include a Wi-Fi transmitter and receiver. The processor 172 may perform calculations, e.g., for adjusting a component of the system 100. The processor 172 may be any as described herein or otherwise known in the art. The processor 172 may be included on the controller 170, or it may be separate from the controller 170, e.g., it may be included on a computing device or an external resource 180 in communication with the controller 170 or another component of the system 100. In an implementation, the processor 172 is included on, or is in communication with, a server that hosts an application for operating and controlling the system 100.

The memory 174 may be any as described herein or otherwise known in the art. The memory 174 may contain computer code and may store data such as sequences of operation, sequences for notifications and alerts, historical data of the system 100, security data, temperature data, tool data, and so on. The memory 174 may contain computer executable code stored thereon that provides instructions for the processor 172 for implementation, e.g., by the controller 170 or a computing device of the system 100. The memory 174 may include a non-transitory computer readable medium.

The system 100 may further include one or more external resources 180. For example, an external resource 180 may include a computing device (which can be a local or remote computing device in communication with one or more of the components of the system 100 including without limitation the controller 170). The computing device may include a user interface (or the user interface may be included on a control panel or elsewhere in the system 100), e.g., in communication with the controller 170. The user interface may be used, e.g., to lock and unlock the system 100, monitor the system 100, set parameters for operation, or otherwise. Such a computing device may include any devices within the system 100 operated by operators or otherwise to manage, monitor, communicate with, or otherwise interact with other participants in the system 100. This may include desktop computers, laptop computers, network computers, tablets, smartphones, smart watches or other wearables, PDAs, or any other device (e.g., IoT device) that can participate in the system 100 as contemplated herein. In an implementation, a computing device (and a user interface thereof) is integral with another participant in the system 100.

An external resource 180, such as a computing device, may include or generally provide a user interface, which may include a graphical user interface, a text or command line interface, a voice-controlled interface, and/or a gesture-based interface. In general, the user interface may create a suitable display (e.g., on a computing device) for operator interaction. In implementations, the user interface may control operation of one or more of the components of the system 100, as well as provide access to and communication with the controller 170, processor 172, and other resources. Such a user interface may be maintained by a locally executing application on a computing device (e.g., tablet) that receives data from one or more of the components of the system 100 or other resources. In other embodiments, such a user interface may be remotely served and presented on a computing device, such as where the controller 170 includes a web server that provides information through one or more web pages or the like that can be displayed within a web browser or similar client executing on a computing device. In implementations, such a user interface may also or instead be provided by and/or disposed on another participant in the system 100.

It will be understood that the heating components—e.g., one or more of the heating element 160, the thermostat 162, and the controller 170—may be powered in the same or similar manner as other components of the wet saw 102, and/or the heating components may be separately and/or independently powered. For example, when the reservoir 150 is outfitted with some or all of the heating components described herein, and where the reservoir 150 is removable and replaceable (e.g., for retrofitting an existing wet saw 102 with the heating components for the coolant), it may be advantageous for the reservoir 150 and/or its heating components to be powered separately from some or all of the other components of the wet saw 102.

Further, the heating components described herein may only require relatively low voltage for operation, which could be beneficial for safety and convenience. That is, while “bucket heaters” and the like tend to be above 1200 Watts (e.g., around 1500 Watts or similar), heating components of the present teachings may use much less power. For example, heating components of the present teachings may use 120 Watts, 240 Watts, or similar. Other power values are also or instead possible. It may be desirous to have relatively low power heaters for safety reasons, e.g., to prevent a user from burning or otherwise injuring themselves if making physical contact with a portion of the system 100, and/or to prevent fire hazards. Further, using a relatively low power heater may prevent a user from blowing breakers when the heater and a tool are operating simultaneously. Moreover, relatively low power heaters may reduce the risk of boiling the coolant in a tool such as a wet saw, thus mitigating burns that can occur, while also permitting the use of less coolant (e.g., because of less concern regarding evaporation). Thus, the present teachings may use less coolant, and thus may take less time to service for re-supplying coolant to a tool system. In certain tests in freezing conditions using a heater with 240 Watts of power, water as a coolant, and an approximately a 10 mph wind, the heater provided a water temperature increase of between 20 and 30 degrees Fahrenheit. Moreover, in these tests, the temperature of the cutting surface 110 (which may also be referred to as a saw plate) in the wind showed approximately an 8 degree Fahrenheit temperature rise over the ambient temperature. When used in conjunction with a small tarp (or the like) that is placed over the tool, this can provide further increases in temperature for both the circulating coolant and the saw plate. Thus, the heating element 160 may act to (indirectly) heat the saw plate or other components of the system 100.

The system 100 may thus include a first power line 191 configured to provide electricity from a first power source 190 to one or more of the motor 130, the pump 140, and/or the heating element 160. In certain aspects, the first power source 190 includes electricity from a power grid, a generator, a battery, and so on. The first power source 190 may thus be in communication with each of the motor 130, the pump 140, and the heating element 160 for providing power thereto for operation thereof in certain aspects.

In certain aspects, the system 100 includes a second power line 192 independent from the first power line 191 and configured to provide electricity to the heating element 160 and/or one or more other components of the coolant heating elements as described herein. In this manner, in certain aspects, the heating element 160 is electrically independent from the first power line 191. The system 100 may further include a second power source 194 configured to provide electricity through the second power line 192 to the heating element 160 (and/or one or more other components of the coolant heating as described herein) for operation thereof. The first power source 190 and the second power source 194 may be different. By way of example, electricity transmitted through the second power line 192 may be low voltage, meaning about 50 volts or less, whereas electricity transmitted through the first power line 191 may be greater than 50 volts, such as 120 volts, 220 volts, or 240 volts. Other voltages are also or instead possible as will be understood. One or more of the first power source 190 and the second power source 194 may include at least one of grid power, a generator, a battery, solar power, wind power, and the like.

The system 100 may further include an electrical connector 196 disposed at a first end 193 of the second power line 192, where the heating element 160 is disposed at a second end of the second power line 192 (which is opposite the first end 193). In some aspects, the electrical connector 196 is disposed on or adjacent to the reservoir 150. In this manner, the reservoir 150 with a heating element 160 therein may lack any external wiring, e.g., merely having an electrical connector that is exposed (e.g., temporarily) for connectivity. In other aspects, the electrical connector 196 is disposed away from the reservoir 150, e.g., along a wire or the like that can be plugged in for operation of one or more of the heating components described herein. The electrical connector 196 may include any as known in the art, such as a plug (male or female), board-to-board connectors, cable/wire-to-cable/wire connectors, cable/wire-to-board connectors, universal serial bus (USB), mini USB, pin connectors or receivers (e.g., 8-pin connectors, 30-pin connectors, and the like), and the like.

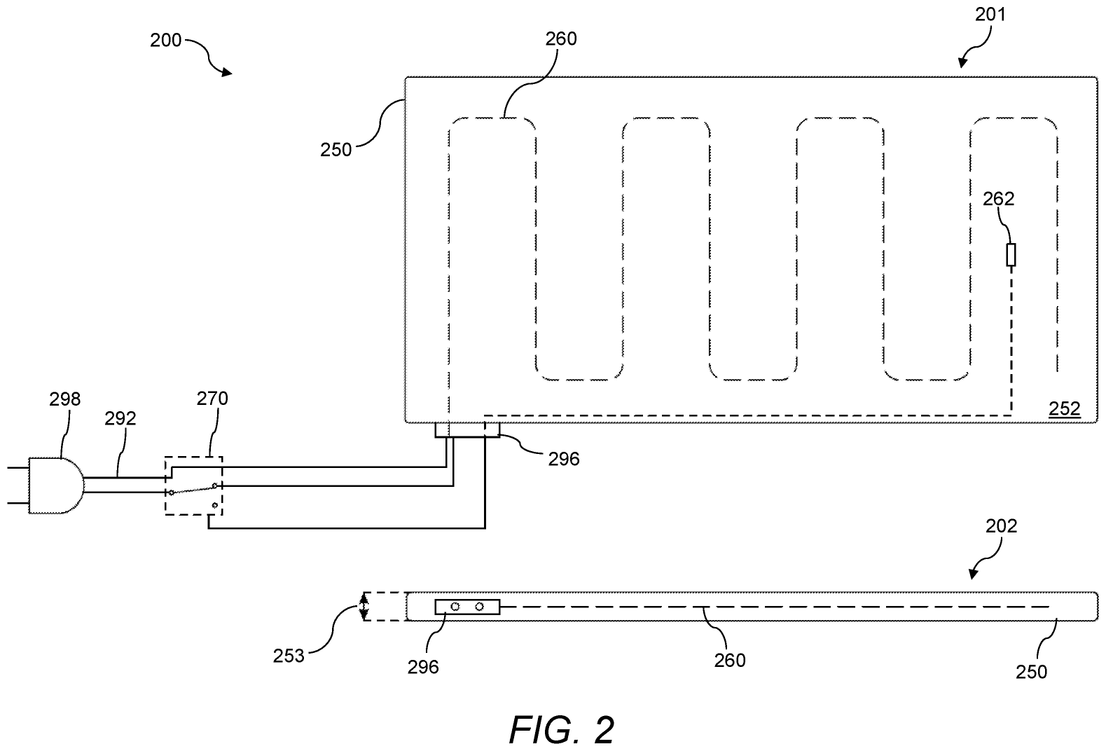

FIG. 2 illustrates a device structurally configured for use with a wet saw, in accordance with a representative embodiment. The device 200 may include any of the components described in the system 100 above with reference to FIG. 1 such as the components configured for heating a coolant for the wet saw 102 described above. In this manner, the device 200 may be structurally configured for use with a wet saw (or similar tool) such as that described above or otherwise known in the art. For example, the device 200 of FIG. 2 may include a reservoir 250 having one or more components that are configured to maintain a threshold temperature (e.g., a temperature above a freezing point) for a coolant to be contained within the reservoir 250.

In particular, FIG. 2 shows two views of the device 200—a first view 201 that represents either a top or bottom view of the reservoir 250, and a second view 202 that represents a cross-sectional side view of the bottom of a reservoir 250. The device 200 may generally include the reservoir 250, a heating element 260, a controller 270, and a thermostat 262, where it will be understood that one or more of these components may be the same or similar to any corresponding components described herein, e.g., with reference to FIG. 1.

The reservoir 250 may include a bottom surface 252 and one or more sidewalls (not shown in FIG. 2) extending upward from the bottom surface 252. The reservoir 250 may define a coolant volume configured to contain a coolant therein. The reservoir 250 may be sized and shaped for inserting within a housing of a wet saw—in this manner, the device 200 may be configured for use in a new and/or an existing wet saw. The reservoir 250 may further include one or more connectors for engagement to at least a portion of a wet saw, where such connectors may include one or more of a specific size and shape for fitting within or otherwise cooperating with a wet saw, a lip, a flange, a void, a projection, a bolt, a cable, a clamp, a clip, a dowel, a gib, a glue, a hook and loop fastener, a latch, a nail, a nut, a pin, a screw, a slider, a spring, and the like. At least one of the bottom surface 252 and one or more of the sidewalls of the reservoir 250 may be made from a thermally conductive resin or similar material(s). In certain aspects, the heating element 260 is disposed within a thickness of at least one of the bottom surface 252 and one or more of the sidewalls of the reservoir 250—e.g., a bottom thickness 253 of the bottom surface 252.

Thus, the heating element 260 may be disposed within one or more of the bottom surface 252 and one or more of the sidewalls of the reservoir 250. The heating element 260 may be selectively activatable to heat coolant contained within the coolant volume of the reservoir 250 for maintaining a minimum predetermined temperature of the coolant contained therein.

The controller 270 may be configured to control operation of the heating element 260. The controller 270 may function as a relatively simplistic on/off switch that can toggle between on/off positions depending on a sensed temperature from the thermostat 262. For example, when the thermostat 262 registers a temperature above a predetermined temperature (e.g., the freezing temperature of a coolant), the controller 270 may provide that the heating element 260 is off or is otherwise not heating, and when the thermostat 262 registers a temperature at, near, or below the predetermined temperature, the controller 270 may activate the heating element 260 so that it is providing heat to contents of the reservoir 250.

The thermostat 262 may be in thermal communication with the coolant volume and configured to sense a temperature of a coolant contained therein. The thermostat 262 may be in communication with the controller 270 to relay the temperature to the controller 270 for activating the heating element 260 when the sensed temperature is a predetermined value. The predetermined value of the sensed temperature may be at or around a freezing point of a coolant contained within the reservoir 250. The predetermined value of the sensed temperature may be adjustable by a user of the device 200. The thermostat 262 may be engaged with one or more of the bottom surface 252 and one or more of the sidewalls of the reservoir 250. For example, the thermostat 262 may be disposed within one or more of the bottom surface 252 and one or more of the sidewalls of the reservoir 250.

The device 200 may include a power line 292 for engagement/communication with a power source for supplying power to one or more components of the device 200. The powerline 292 may be coupled to one or more electrical connectors—e.g., a first connector 296 disposed on or near the reservoir 250, and a second connector 298 on an opposing end of the powerline 292 that is configured to engage with a power source. Thus, in some aspects, the powerline 292 may be completely uncoupled from the reservoir 250, e.g., via disconnecting the powerline 292 from the first connector 296 disposed on the reservoir 250. This may be an advantageous arrangement for embodiments where the reservoir 250 or portions thereof are removable and/or replaceable, e.g., where removing or replacing a reservoir 250 does not necessarily require removing and/or replacing a powerline 292. Thus, in certain aspects, the reservoir 250 may be a relatively compact component that can be unplugged/disengaged with an external powerline 292 via the first connector 296 for, e.g., refilling the reservoir 250 with coolant, replacing the reservoir 250, repairing or servicing the reservoir 250 or contents thereof, cleaning the reservoir 250, and the like. Another advantage of this configuration may include keeping electrical lines substantially isolated from contents of the reservoir 250 such as the coolant, pump, fluid lines, sediment, and the like. In other aspects, the external powerline 292 may be permanently affixed to the reservoir 250 via the first connector 296 or otherwise.

It will be further understood that the powerline 292 may also or instead communicate power to other components of the device 200 or a tool to which the device 200 is coupled—e.g., one or more of the thermostat 262, a pump, a motor, a light, a tool, etc.—or these components may be powered via other, different powerlines or otherwise.

To further achieve a relatively compact, modular reservoir 250 for a tool system such as a wet saw, the pump of such a tool system may be attached to or integral with the reservoir 250 in certain aspects. For example, the pump may be built into a sidewall and/or a bottom surface 252 of the reservoir 250. Also or instead, the pump may be secured to a sidewall and/or a bottom surface 252 of the reservoir 250, e.g., in a selectively releasable manner for repairs and the like. As discussed herein, the pump may be powered in the same or similar manner to the heating element 260—e.g., using the same powerline 292, first connector 296, second connector 298, controller 270, and so on. In other aspects, the pump may be powered separately and independently relative to the heating element 260. In such configurations, the pump may have a similar external connector for engaging a different powerline and/or for the fluid line of the pump.

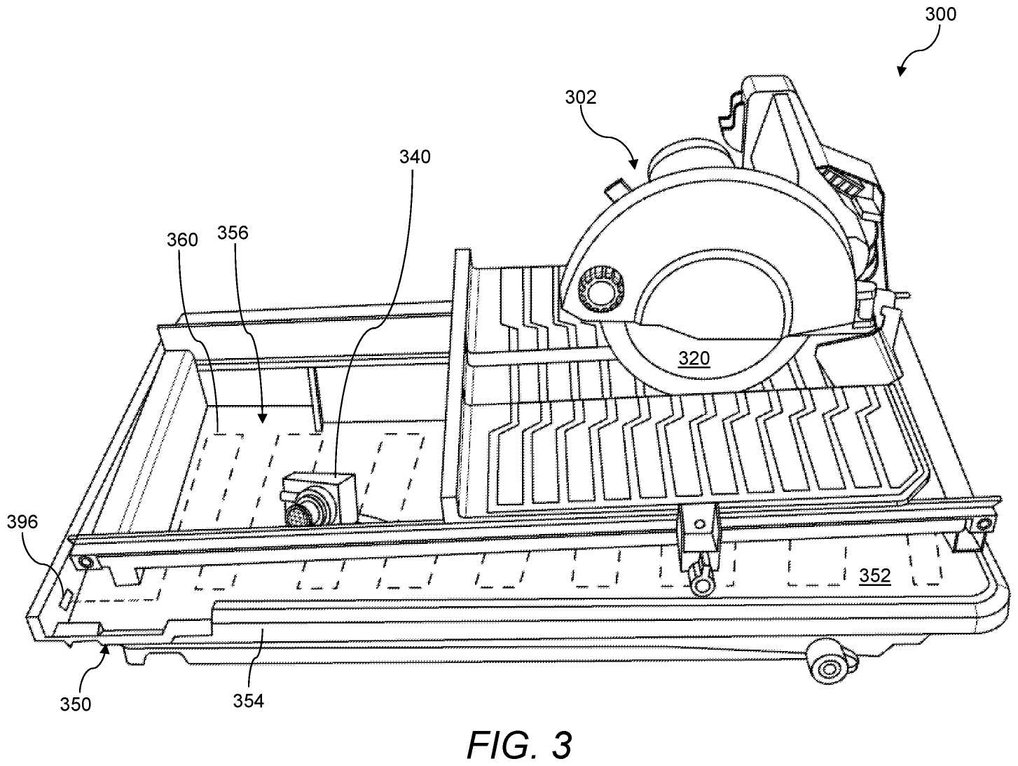

FIG. 3 illustrates a system for cutting tile and similar, in accordance with a representative embodiment. The system 300 may feature any of the components described herein. In particular, shown in this figure are a wet saw 302 (although another type of tool is also or instead possible), a pump 340 within a reservoir 350 having a coolant volume 356 configured to contain a coolant therein (where the pump 340 is structurally configured for distributing the coolant from the coolant volume 356 to other portions of the system 300, e.g., for cooling the blade 320 of the wet saw 302), and a heating element 360, where any of these components may be the same or similar to corresponding components described elsewhere herein.

As shown in the figure, the system 300 may further include an electrical connector 396 for coupling to a power line and/or a power source to provide power (and/or controls) to the heating element 360. And, as further shown in the figure, the electrical connector 396 may be disposed on or adjacent to the reservoir 350—e.g., along a sidewall 354 of the reservoir 350.

As described herein, the heating element 360 may be formed within (or otherwise disposed within) a structure or housing of the reservoir 350—e.g., within a bottom surface 352 and/or one or more sidewalls 354 of the reservoir 350. To this end, the heating element 360 may be disposed along a portion of one or more of the bottom surface 352 and sidewalls 354. In particular, the heating element 360 may include a heat trace line or the like that is distributed/positioned along a portion (e.g., a substantial portion) of the bottom surface 352 of the reservoir 350 as shown in the figure. The heating element 360 may also or instead be disposed in a predetermined pattern or the like.

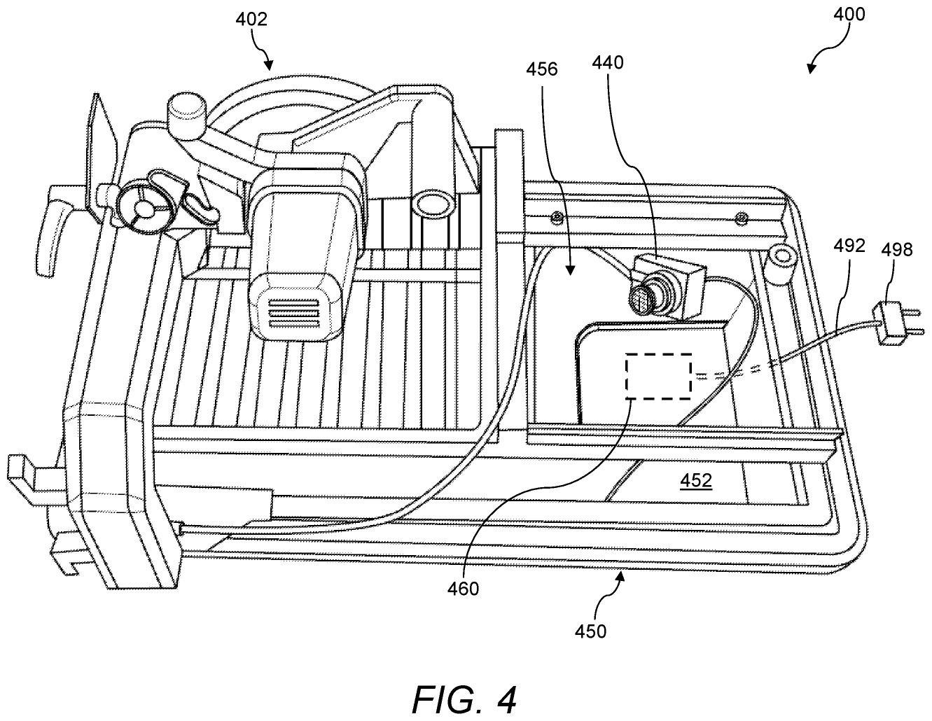

FIG. 4 illustrates a system for cutting tile and similar, in accordance with a representative embodiment. The system 400 may feature any of the components described herein. In particular, shown in this figure are a tool 402, a pump 440 within a reservoir 450 having a coolant volume 456 configured to contain a coolant therein, and a heating element 460, where any of these components may be the same or similar to corresponding components described elsewhere herein.

As shown in the figure, the system 400 may further include a powerline 492 for coupling to a power source via a connector 498 to provide power (and/or controls) to the heating element 460. And, as further shown in the figure, the powerline 492 may extend from the reservoir 450, where portions of the powerline 492 may be integrated into the reservoir 450 and/or they may be disposed external to the reservoir 450.

As described herein, the heating element 460 may be formed within (or otherwise disposed within) a structure or housing of the reservoir 450—e.g., within a bottom surface 452 and/or one or more sidewalls of the reservoir 450. To this end, the heating element 460 may be disposed on or within a surface of the reservoir 450, where the heating element 460 includes a heating pad or the like as shown in the figure. Such a heating pad may be built into the structure of the reservoir 450 and/or coupled thereto. For example, such a heating pad may be formed within the bottom surface 452 of the reservoir 450 such that it is physically separated from the coolant volume 456. Also or instead, such a heating pad may be placed onto the bottom surface 452—e.g., on a side within the coolant volume 456 thereby exposing the heating pad to coolant (and thus the heating element 460 may be waterproof in certain aspects), and/or on a side opposing the coolant volume 456 such that the heating pad is physically isolated from the coolant volume 456. These configurations may also or instead be used with other types of heating elements 460 in addition to or instead of heating pads and the like.

In this manner, FIGS. 3 and 4 may represent other types of tools and tool systems that could benefit from the present teachings. Thus, these figures show a heating element according to the present teachings that may be included within (e.g., integrated into) a tray/basin of these tools.

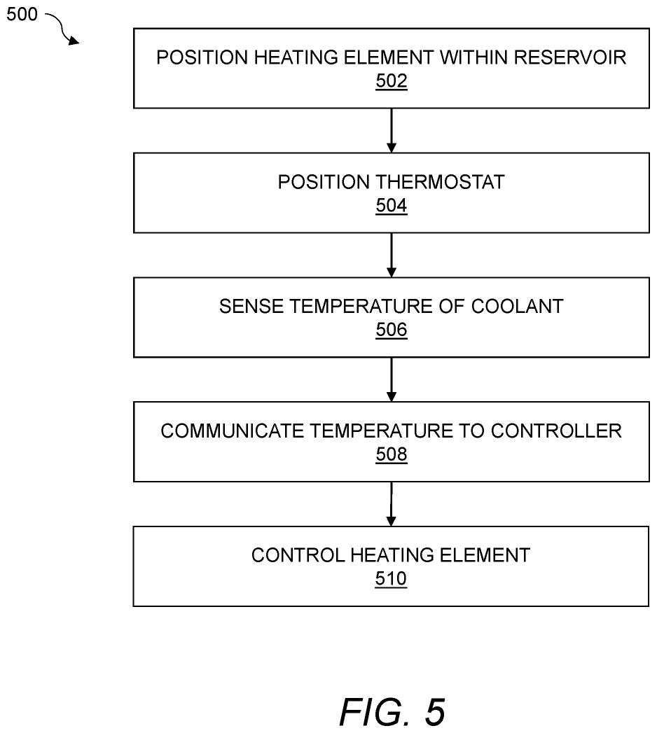

FIG. 5 is a flow chart of a method for controlling temperature of coolant for a tool, in accordance with a representative embodiment. The method 500 may be performed using any of the devices and systems described herein.

As shown in step 502, the method 500 may include positioning a heating element within a reservoir of a tool such as a wet saw and the like. The heating element may be positioned within one or more of a bottom surface and a sidewall of the reservoir, where the reservoir defines a coolant volume configured to contain a coolant therein. Positioning the heating element may include fully encasing the heating element within the reservoir. In this manner, positioning the heating element within the reservoir may include forming the reservoir around the heating element via a manufacturing process including one or more of injection molding, three-dimensional printing or other additive manufacturing, extrusion molding, blow molding, rotational plastic molding, thermoforming, and the like. Also or instead, a portion of the reservoir may be fabricated, and thus structurally configured, to receive a heating element therein—e.g., a slot, pocket, void, casing, and/or the like may be formed in the reservoir for receiving the heating element therein—and thus, positioning the heating element may include adding the heating element to an already formed reservoir, e.g., in a pocket or void defined by a structure of the reservoir. In less preferred implementations, positioning the heating element may include inserting the heating element within the coolant volume where at least a portion thereof is exposed—e.g., when the heating element includes a substantially waterproof heating pad or the like.

As shown in step 504, the method 500 may include positioning a thermostat in thermal communication with the coolant volume. Similar to step 502 above, the thermostat may be positioned within one or more of a bottom surface and a sidewall of the reservoir. Positioning the thermostat may also or instead include encasing at least a portion of the thermostat within the reservoir. In this manner, positioning the thermostat within the reservoir may include forming the reservoir around at least a portion of the thermostat via a manufacturing process including one or more of injection molding, three-dimensional printing or other additive manufacturing, extrusion molding, blow molding, rotational plastic molding, thermoforming, and the like. Also or instead, a portion of the reservoir may be fabricated, and thus structurally configured, to receive a thermostat therein—e.g., a slot, pocket, void, casing, and/or the like may be formed in the reservoir for receiving the thermostat therein—and thus, positioning the thermostat may include adding the thermostat to an already formed reservoir, e.g., in a pocket or void defined by a structure of the reservoir.

As shown in step 506, the method 500 may include sensing, via the thermostat, a temperature of coolant contained within the coolant volume.

As shown in step 508, the method 500 may include communicating the temperature of the coolant as sensed by the thermostat to a controller.

As shown in step 510, the method 500 may include activating, via the controller, the heating element when the temperature of the coolant is below a predetermined threshold such as a temperature at or above the freezing point for the coolant.

Thus, as described herein, the present teachings may include a heated tray for a cutting tool or the like. The heated tray may advantageously keep frozen coolant (e.g., ice) off of the cutting surface (e.g., the cutting plate of a wet saw) and maintain the coolant to a temperature above its freezing point. This can eliminate the need for portable bucket heaters or any other portable cumbersome heater to heat the coolant in cold environments. A heated tray may also be advantageous because, in certain aspects, the heated tray can fit an existing tool— e.g., to replace a non-heated tray.

As described above, the present teachings may be used to increase worker efficiency, reduce power used, and significantly improve worker safety.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionalities may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared, or other device or combination of devices. In another aspect, any of the systems and methods described above may be embodied in any suitable transmission or propagation medium carrying computer-executable code and/or any inputs or outputs from same.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings.

Unless the context clearly requires otherwise, throughout the description, the words “comprise,” “comprising,” “include,” “including,” and the like are to be construed in an inclusive sense as opposed to an exclusive or exhaustive sense; that is to say, in a sense of “including, but not limited to.” Additionally, the words “herein,” “hereunder,” “above,” “below,” and words of similar import refer to this application as a whole and not to any particular portions of this application.

It will be appreciated that the devices, systems, and methods described above are set forth by way of example and not of limitation. For example, regarding the methods provided above, absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

While particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A system for cutting tile and similar, the system comprising:
a cutting surface;
a blade having an edge at least partially exposed along the cutting surface and aligned along a cutting path such that an item placed on the cutting surface and moved along the cutting path toward the blade will contact the edge of the blade;
a motor engaged with the blade to move the blade relative to the cutting surface to facilitate cutting the item when contacting the blade with a predetermined force;
a reservoir including a bottom surface and one or more sidewalls extending upward from the bottom surface, the reservoir defining a coolant volume configured to contain a coolant therein;
a pump in fluid communication with the coolant volume;
a fluid line structurally configured to deliver coolant moved via the pump from the coolant volume to the blade when the pump is actuated; and
a heating element disposed within one or more of the bottom surface and the one or more sidewalls of the reservoir, the heating element selectively activatable to heat coolant contained within the coolant volume to maintain a minimum predetermined temperature thereof.

2. The system of claim 1, wherein the heating element is physically isolated from coolant contained within the coolant volume.

3. The system of claim 1, wherein the reservoir is removable and replaceable within the system.

4. The system of claim 1, wherein at least one of the bottom surface and the one or more sidewalls is made from a thermally conductive resin.

5. The system of claim 1, further comprising a controller configured to control operation of the heating element.

6. The system of claim 5, further comprising a thermostat in thermal communication with the coolant volume and configured to sense a temperature of coolant contained therein, the thermostat in communication with the controller to relay the temperature to the controller for activating the heating element when the sensed temperature is a predetermined value.

7. The system of claim 6, wherein the predetermined value of the sensed temperature is the minimum predetermined temperature.

8. The system of claim 6, wherein the predetermined value of the sensed temperature is adjustable by a user of the system.

9. The system of claim 1, further comprising a first power line configured to provide electricity from a first power source to one or more of the motor, the pump, and the heating element.

10. The system of claim 9, further comprising a second power line independent from the first power line and configured to provide electricity to the heating element, wherein the heating element is electrically independent from the first power line.

11. The system of claim 10, further comprising a second power source configured to provide electricity through the second power line to the heating element for operation thereof.

12. The system of claim 11, wherein the first power source and the second power source are different.

13. The system of claim 10, wherein electricity transmitted through the second power line is 50 volts or less.

14. The system of claim 10, further comprising an electrical connector disposed at a first end of the second power line, wherein the heating element is disposed at a second end of the second power line.

15. The system of claim 14, wherein the electrical connector is disposed on or adjacent to the reservoir.

16. A device structurally configured for use with a wet saw, the device comprising:
a reservoir including a bottom surface and one or more sidewalls extending upward from the bottom surface, the reservoir defining a coolant volume configured to contain a coolant therein;
a heating element disposed within one or more of the bottom surface and the one or more sidewalls of the reservoir, the heating element selectively activatable to heat coolant contained within the coolant volume to maintain a minimum predetermined temperature thereof;
a controller configured to control operation of the heating element; and
a thermostat in thermal communication with the coolant volume and configured to sense a temperature of coolant contained therein, the thermostat in communication with the controller to relay the temperature to the controller for activating the heating element when the sensed temperature is a predetermined value.

17. The device of claim 16, wherein the reservoir is sized and shaped for inserting within a housing of a wet saw.

18. The device of claim 16, wherein the predetermined value is above a freezing point of coolant contained within the coolant volume.

19. A method, comprising:
positioning a heating element within one or more of a bottom surface and a sidewall of a reservoir of a wet saw, the reservoir defining a coolant volume configured to contain a coolant therein;
positioning a thermostat in thermal communication with the coolant volume;
sensing, via the thermostat, a temperature of coolant contained within the coolant volume;
communicating the temperature of the coolant as sensed by the thermostat to a controller; and
activating, via the controller, the heating element when the temperature of the coolant is below a predetermined threshold.

20. The method of claim 19, wherein positioning the heating element within the reservoir includes forming the reservoir around the heating element via a manufacturing process including one or more of injection molding, three-dimensional printing, and thermoforming.
